(19) United States
(12) Patent Application Publication
(10) Pub. No.: US 2024/0320948 A1
(43) Pub. Date: Sep. 26, 2024

(54) OBJECT DETECTION SYSTEM AND OBJECT DETECTION METHOD

(71) Applicant: NEC Corporation, Tokyo (JP)

(72) Inventor: Seiya SHIBATA, Tokyo (JP)

(73) Assignee: NEC Corporation, Tokyo (JP)

(21) Appl. No.: 18/599,715

(22) Filed: Mar. 8, 2024

(30) Foreign Application Priority Data
Mar. 23, 2023 (JP) 2023-046155

(51) Int. Cl. G06V 10/25; G06V 10/22

(52) U.S. Cl. CPC G06V 10/25; G06V 10/23; G06V 2201/07; G06V 2201/10

(57) ABSTRACT

An object detection system that can achieve both low delay and object detection accuracy is provided. A first detection unit identifies labels of objects reflected in a input frame and locations of bounding boxes of the objects. A history information generation unit assigns the same ID to the bounding boxes that share the same object, and generates history information that is information indicating a history of combination of a frame number and a location of a bounding box for each ID. A prediction unit predicts regions of the bounding boxes in latest frame, based on the history information, according to a delay that is a time required for the first detection unit to identify the labels and the locations of the bounding boxes in the input frame.

### INCORPORATION BY REFERENCE

This application is based upon and claims the benefit of priority from Japanese patent application No. 2023-046155, filed on Mar. 23, 2023, the disclosure of which is incorporated herein in its entirety by reference.

### TECHNICAL FIELD

The present invention relates to an object detection system, an object detection method, and an object detection program for detecting an object reflected in an image frame (hereinafter referred to as “frame”).

### BACKGROUND ART

A series of frames generated by a high-resolution camera may be input to an object detection system, and the object detection system may detect an object from each frame.

The number of pixels in a frame generated by the high-resolution camera is large. When an object is detected in a high-resolution frame (i.e., a frame with a large number of pixels), it takes longer to detect the object.

There are also small and lightweight detection algorithms and model structures that can detect an object in a short time in a high-resolution frame, but the accuracy of object detection is reduced in such cases.

PTL 1 describes a video analysis system that recognizes an object in video images and identifies the type of the object.

PTL 2 describes a scanner including a high-speed image processing unit for high-speed mode and a low-speed image processing unit for low-speed mode.

### CITATION LIST

### Patent Literature

PTL 1: Japanese Patent Application Laid-Open No. 2022-133547
PTL 2: Japanese Patent Application Laid-Open No. 2019-41332

### SUMMARY

The purpose of the present invention is to provide an object detection system, an object detection method, and an object detection program that can achieve both low delay and object detection accuracy.

An object detection system according to the present invention is an object detection system to which frames are input continuously, including: a memory storing instructions; and a processor configured to execute the instructions to implement: a first detection unit that identifies labels of objects reflected in a input frame and locations of bounding boxes of the objects; a history information generation unit that assigns the same ID to the bounding boxes that share the same object, and generates history information that is information indicating a history of combination of a frame number and a location of a bounding box for each ID; a prediction unit that predicts regions of the bounding boxes in latest frame, based on the history information, according to a delay that is a time required for the first detection unit to identify the labels and the locations of the bounding boxes in the input frame; and a second detection unit that identifies labels of reflected objects and locations of bounding boxes, in predicted regions of the bounding boxes in the latest frame; wherein processing time for the second detection unit to identify the labels and the locations of the bounding boxes for one frame is shorter than processing time for the first detection unit to identify the labels and the locations of the bounding boxes for the one frame.

An object detection method according to the present invention is an object detection method applied to a computer to which frames are input continuously, including: executing a first detection process of identifying labels of objects reflected in a input frame and locations of bounding boxes of the objects; executing a history information generation process of assigning the same ID to the bounding boxes that share the same object, and generating history information that is information indicating a history of combination of a frame number and a location of a bounding box for each ID; executing a prediction process of predicting regions of the bounding boxes in latest frame, based on the history information, according to a delay that is a time required in the first detection process to identify the labels and the locations of the bounding boxes in the input frame; and executing a second detection process of identifying labels of reflected objects and locations of bounding boxes, in predicted regions of the bounding boxes in the latest frame; wherein processing time in the second detection process to identify the labels and the locations of the bounding boxes for one frame is shorter than processing time in the first detection process to identify the labels and the locations of the bounding boxes for the one frame.

A non-transitory computer-readable recording medium according to the present invention is a non-transitory computer-readable recording medium in which an object detection program is recorded, wherein the object detection program is to be installed in a computer to which frames are input continuously, and the object detection program causes the computer to execute: a first detection process of identifying labels of objects reflected in a input frame and locations of bounding boxes of the objects; a history information generation process of assigning the same ID to the bounding boxes that share the same object, and generating history information that is information indicating a history of combination of a frame number and a location of a bounding box for each ID; a prediction process of predicting regions of the bounding boxes in latest frame, based on the history information, according to a delay that is a time required in the first detection process to identify the labels and the locations of the bounding boxes in the input frame; and a second detection process of identifying labels of reflected objects and locations of bounding boxes, in predicted regions of the bounding boxes in the latest frame; wherein processing time in the second detection process to identify the labels and the locations of the bounding boxes for one frame is shorter than processing time in the first detection process to identify the labels and the locations of the bounding boxes for the one frame.

### BRIEF DESCRIPTION OF THE DRAWINGS

FIG. 1 It depicts a block diagram showing an example configuration of an object detection system of the first example embodiment of the present invention.

FIG. 2 It depicts a schematic diagram showing an example of history information.

FIG. 3 It depicts a flowchart showing an example of the processing flow of the object detection system of the first example embodiment.

FIG. 4 It depicts a block diagram showing an example configuration of an object detection system of the second example embodiment of the present invention.

FIG. 5 It depicts a flowchart showing an example of the processing flow of the object detection system of the second example embodiment.

FIG. 6 It depicts a block diagram showing an example configuration of an object detection system of the third example embodiment of the present invention.

FIG. 7 It depicts a schematic diagram showing an example of multiple prediction regions ordered by the ordering unit.

FIG. 8 It depicts a block diagram showing an example of an object detection system that uses the time when a frame is input.

FIG. 9 It depicts a schematic block diagram showing an example configuration of a computer related to the object detection system of the present invention.

FIG. 10 It depicts a block diagram showing an overview of the object detection system of the present invention.

### EXAMPLE EMBODIMENT

The following is a description of the example embodiments of the present invention with reference to the drawings.

Example Embodiment 1

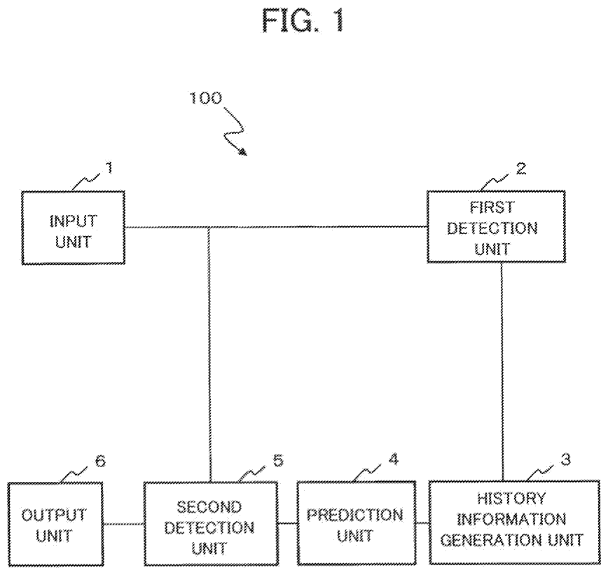

FIG. 1 is a block diagram showing an example configuration of an object detection system of the first example embodiment of the present invention. The object detection system 100 includes an input unit 1, a first detection unit 2, a history information generation unit 3, a prediction unit 4, a second detection unit 5, and an output unit 6.

Frames generated by the shooting by the high-resolution camera are continuously input to the object detection system 100. The frames that are input continuously are assigned sequential frame numbers.

The input unit 1 is an input interface where each frame is input. In each example embodiment, each frame is assumed to be input to the input unit 1 at a constant frame rate.

In the first example embodiment, when a frame is input to the input unit 1, the frame is sent to the first detection unit 2 and the second detection unit 5, respectively.

The first detection unit 2 detects an object in the input frame. Here, “detecting an object” means identifying a label of the object reflected in the input frame and location of a bounding box of the object.

The label is a label indicating the type of reflected object. For example, when the objects to be detected are a car and a person, the label “car” or “person” is identified as the label of the object. For simplicity of explanation, the following example is based on the case where the object to be detected is only a person.

The first detection unit 2, for example, maintains a model generated in advance by machine learning such as deep learning. The first detection unit 2 identifies the label of the object reflected in the frame and the location of the bounding box of the object by applying the entire single input frame to the model. The number of objects detected from a single frame is not limited to one, but may be multiple. In this case, for each object, the first detection unit 2 identifies the label of the object and the location of the bounding box of the object.

The second detection unit 5, described below, also identifies the label of the object reflected in the input frame and the location of the bounding box of the object. In other words, the second detection unit 5 also detects the object. However, the detection accuracy of the first detection unit 2 is higher than that of the second detection unit 5.

When the first detection unit 2 identifies the label of the object reflected in the input frame and the location of the bounding box of the object, the first detection unit 2 outputs the frame number of the frame, the label, and the location of the bounding box to the history information generation unit 3.

At the point when the first detection unit 2 outputs the frame number, the label, and the location of the bounding box with respect to the input frame to the history information generation unit 3, another new frame is input via the input unit 1, and the new frame is input to the second detection unit 5.

It takes time for the first detection unit 2 to identify the label of the object and the location of the bounding box of the object with respect to a single frame. This time is a delay. The delay in the second detection unit 5 is smaller than the delay in the first detection unit 2. In other words, the processing time for the second detection unit 5 to identify the label and the location of the bounding box for one frame is shorter than the processing time for the first detection unit 2 to identify the label and the location of the bounding box for the one frame.

The communication time for one frame to reach the first detection unit 2 may be included in the delay in the first detection unit 2.

In the present example embodiment, the magnitude of the delay in the first detection unit 2 is expressed as the difference between the frame number of the frame in which the first detection unit 2 identifies the label of the object and the location of the bounding box of the object, and the frame number of the frame input to the second detection unit 5 at the time the first detection unit 2 outputs the label and the location of the bounding box.

In the first example embodiment, it is assumed that the magnitude of the delay in the first detection unit 2 is constant. In other words, it is assumed that the difference between the frame number of the frame in which the first detection unit 2 identifies the label of the object and the location of the bounding box of the object, and the frame number of the frame input to the second detection unit 5 at the time the first detection unit 2 outputs the label and the location of the bounding box is constant. Let k be this difference in frame numbers.

When the history information generation unit 3 is given the frame number, the label of the object, and the location of the bounding box of the object from the first detection unit 2, the history information generation unit 3 assigns an ID to the bounding box. When multiple locations of the bounding boxes are given, the history information generation unit 3 assigns an ID to each bounding box. In this case, the history information generation unit 3 assigns the same ID to the bounding boxes that share the same object (in other words, the bounding boxes that are guessed to share the same object).

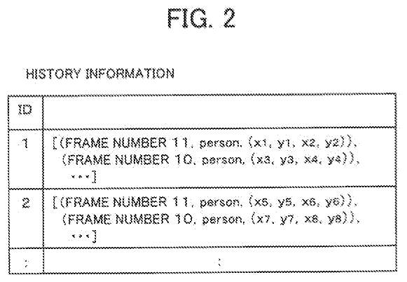

The history information generation unit 3 also generates history information. The history information is information that indicates the history of the combination of the frame number and the location of the bounding box for each ID. FIG. 2 is a schematic diagram showing an example of the history information. The example shown in FIG. 2 shows the history of the combination of the frame number, the label, and the location of the bounding box for each ID of the bounding box. In this example, the location of the bounding box is identified by the coordinates of the upper left vertex and the coordinates of the lower right vertex of the bounding box. For example, (x₁, y₁) shown in FIG. 2 are the coordinates of the upper left vertex of the bounding box and (x₂, y₂) are the coordinates of the lower right vertex of the bounding box.

When the history information generation unit 3 generates the latest history information, the history information generation unit 3 outputs the history information to the prediction unit 4.

The prediction unit 4 predicts the region of the bounding box in the latest input frame according to the delay and based on the history information. The prediction unit 4 predicts the region of the bounding box in the latest frame for each ID of the bounding box.

In the present example embodiment, the magnitude of the delay is constant. And, as mentioned above, the difference between the frame number of the frame in which the first detection unit 2 identifies the label of the object and the location of the bounding box of the object, and the frame number of the frame input to the second detection unit 5 at the time the first detection unit 2 outputs the label and the location of the bounding box is constant, and this difference is denoted by k.

Therefore, the prediction unit 4 predicts the region of the bounding box in a frame k frames later than the frame with the latest frame number in the history information (in the example shown in FIG. 2, the frame with frame number 11).

The prediction unit 4 may predict the region of the bounding box in the latest frame by the linear prediction based on the history information.

Alternatively, the prediction unit 4 may predict the region of the bounding box in the latest frame by the Kalman filter based on the history information.

Alternatively, the prediction unit 4 may predict the region of the bounding box in the latest frame by AI (Artificial Intelligence) utilizing deep learning, etc., based on history information.

The history information illustrated in FIG. 2 contains a history of the combination of the frame number, the label, and the location of the bounding box for each ID of the bounding box. Thus, the prediction unit 4 can use that history to predict the region of the bounding box in the latest frame by the linear prediction, the Kalman filter, or AI-based prediction.

The prediction unit 4 outputs information indicating the predicted region of the bounding box in the latest frame to the second detection unit 5.

The processing time of the history information generation unit 3 and the prediction unit 4 is negligibly short. Alternatively, this processing time takes a certain amount of time. In this case, this processing time may be included in the number of delayed frames k.

The second detection unit 5 identifies the label of the reflected object and the location of the bounding box of the object in the region of the bounding box predicted by the prediction unit 4 in the latest input frame. When there are multiple regions of the bounding boxes predicted by the prediction unit 4, the second detection unit 5 identifies the label of the reflected object and the location of the bounding box of the object for each predicted region of the bounding box. The identified location of the bounding box may match the predicted region of the bounding box.

The second detection unit 5, for example, maintains a model generated in advance by machine learning such as deep learning. Then, by applying the predicted region of the bounding box in the latest frame to the model, the second detection unit 5 identifies the label of the reflected object and the location of the bounding box of the object. The size of the model maintained by the second detection unit 5 may be smaller than the size of the model maintained by the first detection unit 2.

The second detection unit 5 outputs the identified label of the object and the location of the bounding box to the outside of the object detection system 100 via the output unit 6.

The output unit 6 is an output interface for outputting the label of the object and the location of the bounding box.

The first detection unit 2, the history information generation unit 3, the prediction part 4, and the second detection unit 5 are realized, for example, by a CPU (Central Processing Unit) of a computer operating according to an object detection program. In this case, the CPU may read the object detection program from a program storage medium such as a program storage device of the computer, and operate as the first detection unit 2, the history information generation unit 3, the prediction unit 4, and the second detection unit 5 according to the object detection program.

The configuration may also be such that the prediction unit 4, the second detection unit 5, and the output unit 6 are mounted on an FPGA (Field Programmable Gate Array), while the input unit 1, the first detection unit 2, and the history information generation unit 3 are mounted on an AI chip, and frames are input to the AI chip via PCIe (Peripheral Component Interconnect Express).

The configuration may also be such that the prediction unit 4, the second detection unit 5, and the output unit 6 are mounted on an edge device, while the input unit 1, the first detection unit 2, and the history information generation unit 3 are mounted on a server, and frames are input to the server via the communication network.

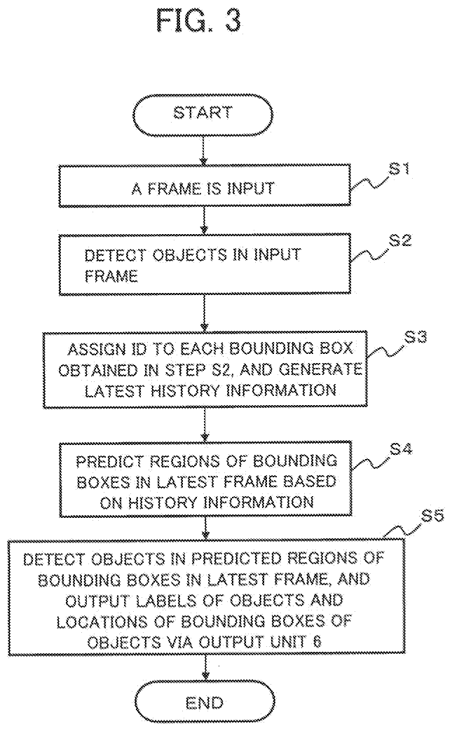

Next, the processing flow is described. FIG. 3 is a flowchart showing an example of the processing flow of the object detection system of the first example embodiment. The explanation of matters that have already been explained are omitted as appropriate.

Frames are continuously input to the object detection system 100. When a frame is input to the input unit 1 (step S1), the frame is sent to the first detection unit 2.

The first detection unit 2 detects objects in the input frame (step S2). That is, the first detection unit 2 identifies the labels of the objects reflected in the frame and the locations of the bounding boxes of the objects. The first detection unit 2 outputs the frame number of the frame, the labels, and the locations of the bounding boxes to the history information generation unit 3.

The history information generation unit 3 assigns an ID to each bounding box obtained in step S2. In this case, the history information generation unit 3 assigns the same ID to the bounding boxes that share the same object. Then, the history information generation unit 3 generates the latest history information (step S3). The history information generation unit 3 outputs the latest history information to the prediction unit 4.

The Prediction unit 4 predicts the regions of the bounding boxes in the latest frame based on the history information generated in step S3 (step S4). Specifically, the prediction unit 4 predicts the regions of the bounding boxes in the frame k frames later than the frame with the latest frame number in the history information (in the example shown in FIG. 2, the frame with frame number 11). The prediction unit 4 then outputs information indicating the predicted regions to the second detection unit 5.

At this time, the latest frame is input to the second detection unit 5.

The second detection unit 5 detects objects in the predicted regions of the bounding boxes in the latest frame. That is, the second detection unit 5 identifies the labels of the objects reflected in the regions and the locations of the bounding boxes of the object, in the predicted regions of the bounding boxes. The second detection unit 5 then outputs the labels and the locations of the bounding boxes via the output unit 6 (step S5).

In the present example embodiment, the prediction unit 4 predicts the regions of the bounding boxes in the latest frame. When the prediction unit 4 outputs the prediction result (information indicating the predicted regions) to the second detection unit 5, the latest frame is input to the second detection unit 5. Therefore, even if there is a delay in the first detection unit 2, the second detection unit 5 can identify the labels of the objects reflected in the regions and the locations of the bounding boxes of the object, in the predicted regions of the bounding boxes in the latest frame.

In addition, the delay in the second detection unit 5 is small. Therefore, when the second detection unit 5 receives the latest frame, the second detection unit 5 can identify the labels of the reflected objects and the locations of the bounding boxes of the objects in almost real time, and output the labels and the locations of the bounding boxes via output unit 6. The second detection unit 5 does not detect objects over an entire frame, but in predicted regions within a single frame. Therefore, the second detection unit 5 can detect objects in a short time and with high accuracy. Therefore, according to the present example embodiment, both low delay and object detection accuracy can be achieved with respect to object detection.

### Example Embodiment 2

In the first example embodiment, the case in which the magnitude of the delay in the first detection unit 2 is constant was shown. The second example embodiment is an example embodiment in which the same effect as the first example embodiment can be obtained even when the magnitude of this delay varies.

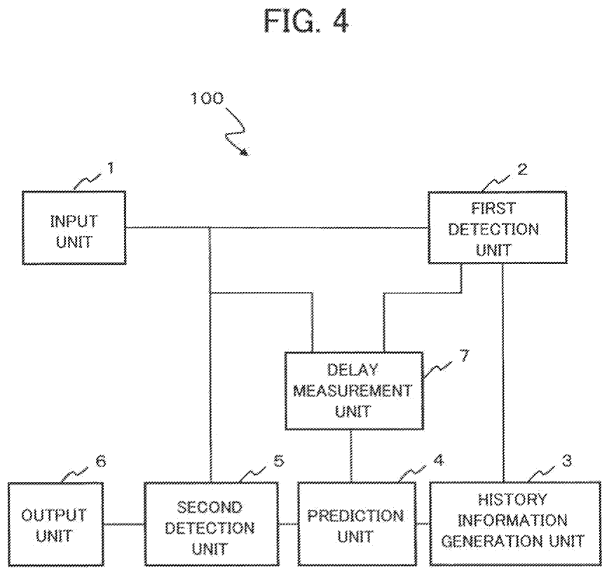

FIG. 4 is a block diagram showing an example configuration of an object detection system of the second example embodiment of the present invention. The same components as those of the first example embodiment are marked with the same signs as those shown in FIG. 1, and detailed descriptions are omitted. The object detection system 100 includes an input unit 1, a first detection unit 2, a delay measurement unit 7, a history information generation unit 3, a prediction unit 4, a second detection unit 5, and an output unit 6.

The input unit 1, the history information generation unit 3, the second detection unit 5, and the output unit 6 are the same as the input unit 1, the history information generation unit 3, the second detection unit 5, and the output unit 6 (see FIG. 1) in the first example embodiment and their description is omitted.

The delay measurement unit 7 measures the magnitude of the delay in the first detection unit 2.

When a new frame is input to the input unit 1, the new frame is sent to the first detection unit 2 and the second detection 5, respectively. At this time, the delay measurement unit 7 obtains the frame number of the new frame. The new frame may also be sent to the delay measurement unit 7, which obtains the frame number of the frame.

The first detection unit 2 operates in the same manner as the first detection unit 2 (see FIG. 1) in the first example embodiment. Furthermore, when the first detection unit 2 outputs the frame number, the label, and the location of bounding box to the history information generation unit 3, the first detection unit 2 also outputs the frame number to the delay measurement unit 7. This frame number is the frame number of the frame in which the label of the reflected object and the location of the bounding box of the object are identified by the first detection unit 2.

At this time, the delay measurement unit 7 obtains the frame number of the latest frame input.

The delay measurement unit 7 measures the difference between the frame number of the latest frame and the frame number given by the first detection unit 2 as the magnitude of the delay in the first detection unit 2. The measured difference of the frame numbers is denoted by n. Since the magnitude of the delay varies in the present example embodiment, the value of the difference n of the frame numbers also varies. The delay measurement unit 7 outputs the difference n of the frame numbers to the prediction unit 4.

The prediction unit 4 predicts the region of the bounding box within the latest frame input, based on the history information according to the difference n. Specifically, the prediction unit 4 predicts the region of the bounding box in the frame n frames later than the frame with the latest frame number in the history information (in the example shown in FIG. 2, the frame with frame number 11).

The prediction unit 4 may predict the region of the bounding box in the latest frame by the linear prediction based on the history information.

Alternatively, the prediction unit 4 may predict the region of the bounding box in the latest frame by the Kalman filter based on the history information.

The prediction unit 4 outputs information indicating the predicted region of the bounding box in the latest frame to the second detection unit 5.

The processing time of the delay measurement unit 7, the history information generation unit 3, and the prediction unit 4 is negligibly short.

The delay measurement unit 7 is realized, for example, by a CPU of a computer operating according to an object detection program, similar to the first detection unit 2, the history information generation unit 3, the prediction unit 4 and the second detection unit 5.

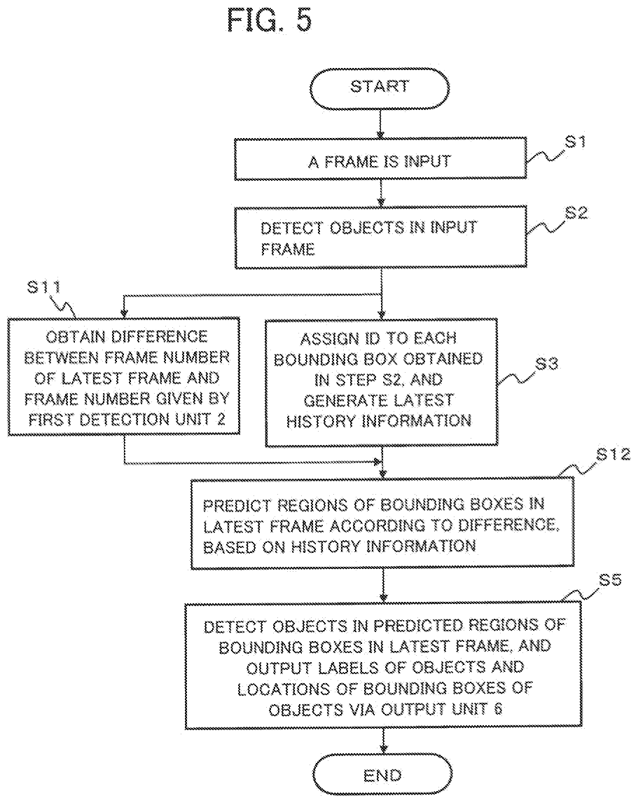

Next, the processing flow is described. FIG. 5 is a flowchart showing an example of the processing flow of the object detection system of the second example embodiment. For processes similar to those in the first example embodiment, the same step numbers as those shown in FIG. 3 are used and explanations are omitted.

Step S1 and step S2 are the same as step S1 and step S2 in the first example embodiment (see FIG. 3). However, in step S2, when the first detection unit 2 outputs the frame number, the labels, and the locations of the bounding boxes to the history information generation unit 3, the first detection unit 2 also outputs the frame number to the delay measurement unit 7. At this time, the delay measurement unit 7 obtains the frame number of the latest frame input.

The delay measurement unit 7 obtains the difference n between the frame number of the latest frame and the frame number given by the first detection unit 2 (step S11).

Step S3 is the same as step S3 in the first example embodiment (see FIG. 3).

After steps S11 and S3 are completed, the prediction unit 4 predicts the regions of the bounding boxes in the latest frame according to the difference n obtained in step S11, based on the history information generated in step S3 (step S12). Specifically, the prediction unit 4 predicts the regions of the bounding boxes in the frame n frames later than the frame with the latest frame number in the history information. The prediction unit 4 outputs information indicating the predicted region to the second detection unit 5.

At this time, the latest frame is input to the second detection unit 5.

Step S5 is the same as step S5 in the first example embodiment (see FIG. 3).

In the present example embodiment, even if the magnitude of the delay in the first detection unit 2 varies, the delay measurement unit 7 expresses the magnitude of the delay in terms of the difference in frame numbers. Moreover, the prediction unit 4 predicts the regions of the bounding boxes in the latest frame according to the difference. Therefore, the same effect as in the first example embodiment is obtained in the second example embodiment.

### Example Embodiment 3

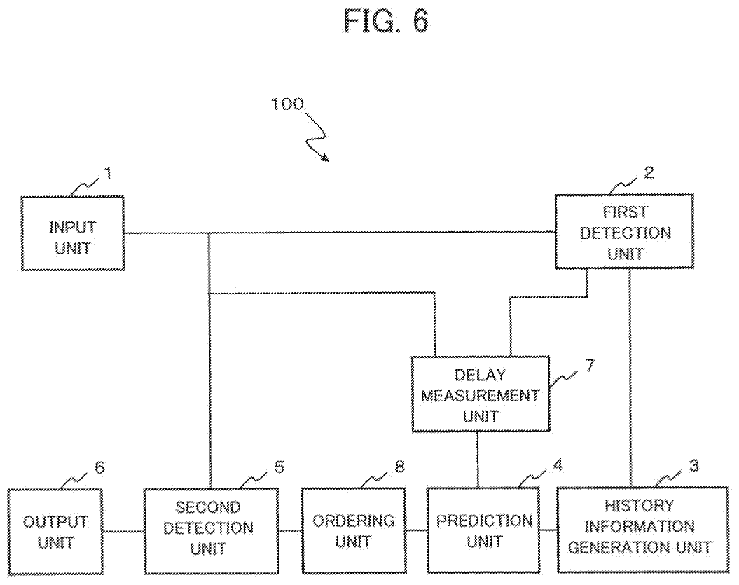

In the third example embodiment, the object detection system outputs to the external system (not shown) the label of an object and the location of the bounding box of the object for each input frame. When multiple objects are reflected in a single frame, the object detection system (specifically, the second detection unit 5 shown in FIG. 6) outputs the labels of the objects and the locations of the bounding boxes of the objects, for the frame, in sequence, to the external system.

When the external system described above detects objects (in this example, persons) that are close to each other and facing in the direction of movement, the external system sends an alert to the terminals held by the persons, stating that the person may collide with another person. The method by which the external system detects objects that are close to each other and facing in the direction of movement is not limited.

FIG. 6 is a block diagram showing an example configuration of an object detection system of the third example embodiment of the present invention. The same components as those of the first example embodiment and the second example embodiment are marked with the same signs as those shown in FIG. 1 and FIG. 4, and detailed descriptions are omitted. The object detection system 100 of the third example embodiment includes an input unit 1, a first detection unit 2, a delay measurement unit 7, a history information generation unit 3, a prediction unit 4, an ordering unit 8, a second detection unit 5, and an output unit 6. FIG. 6 shows an example of the second embodiment (see FIG. 4) with the ordering unit 8 added, but the configuration may be the first embodiment (see FIG. 1) with the ordering unit 8 added.

The input unit 1, the first detection unit 2, the delay measurement unit 7, the history information generation unit 3, and the output unit 6 are the same as the input unit 1, the first detection unit 2, the delay measurement unit 7, the history information generation unit 3, and the output unit 6 (see FIG. 4) in the second example embodiment and their description is omitted.

The ordering unit 8 performs ordering on the regions of the bounding boxes predicted by the prediction unit 4.

The second detection unit 5 selects the predicted region of the bounding box in the order determined by the ordering unit 8, and identifies the label of the reflected object and the location of the object, in the region. As soon as the second detection unit 5 identifies the label of the object and the location of the bounding box, the second detection unit 5 immediately outputs the label and the location of the bounding box to the external system via the output unit 6.

When the condition that the distance between the two predicted regions of the bounding boxes is equal to or less than a predetermined threshold and the direction of movement of the two bounding boxes is facing each other are met, the ordering unit 8 determines that the order of the two region of the bounding boxes is earlier than the order of the regions of the bounding boxes that do not meet the condition. The ordering unit 8 then outputs the information indicating the predicted regions to the second detection unit 5 according to the established order.

The prediction unit 4 predicts the regions of the bounding boxes within the latest frame input and outputs information indicating the predicted regions to the ordering unit 8. At this time, the prediction unit 4 predicts the region of the bounding box in the latest frame for each ID of the bounding box. Based on the history information, the prediction unit 4 derives a vector indicating the direction and speed of movement of the bounding box (hereinafter referred to as the motion vector) for each ID of the bounding box. The prediction unit 4 also outputs the motion vector derived for each ID to the ordering unit 8. The ordering unit 8 can use the motion vector of the bounding box derived for each ID to determine whether or not the two predicted regions meet the above condition.

The ordering unit 8 is realized, for example, by a CPU of a computer operating according to an object detection program, similar to the first detection unit 2, the history information generation unit 3, the delay measurement unit 7, the prediction unit 4 and the second detection unit 5.

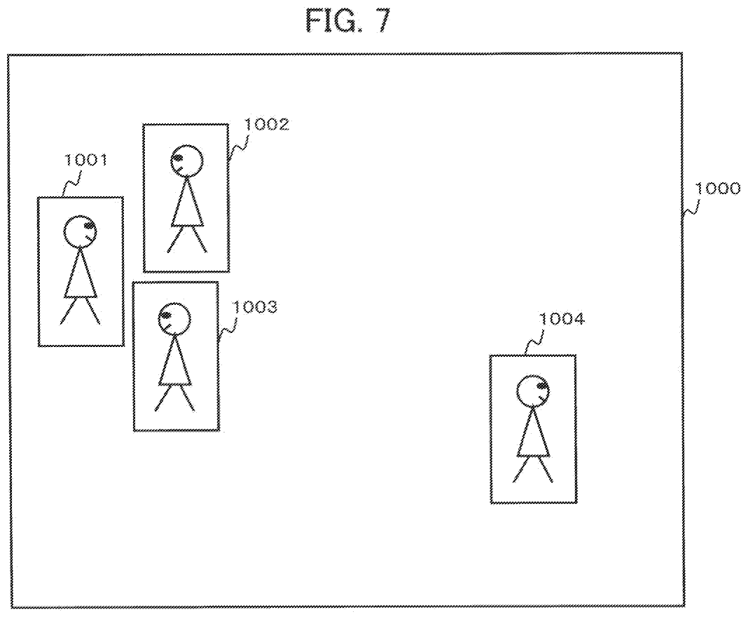

The following is an example of how the ordering unit 8 performs ordering on the predicted regions of the bounding boxes. Hereafter, the predicted regions of the bounding boxes are referred to as prediction regions. FIG. 7 is a schematic diagram showing an example of multiple prediction regions ordered by the ordering unit 8. It is assumed that four prediction regions 1001-1004 are defined in frame 1000 by prediction unit 4 (see FIG. 7).

Focusing on prediction regions 1001 and 1002, these two prediction regions 1001 and 1002 meet the aforementioned condition.

Similarly, focusing on prediction regions 1001 and 1003, these two prediction regions 1001 and 1003 meet the aforementioned condition.

The aforementioned condition is not met by combining prediction region 1004 with any of the other prediction regions.

Thus, in the example shown in FIG. 7, the ordering unit 8 orders the order of the prediction regions 1001, 1002, and 1003 earlier than the order of the prediction region 1004. The ordering unit 8 may arbitrarily determine the order of the three prediction regions 1001, 1002, and 1003. In this example, it is assumed that the ordering is performed in the order of prediction region 1001, prediction region 1002, prediction region 1003, and prediction region 1004.

The second detection unit 5 first selects the prediction region 1001 and identifies the label of the object reflected in the prediction region 1001 and the location of the bounding box of the object. The second detection unit 5 then outputs the label and the location of the bounding box to the external system.

Next, the second detection unit 5 selects the prediction region 1002 and identifies the label of the object reflected in the prediction region 1002 and the location of the bounding box of the object. The second detection unit 5 then outputs the label and the location of the bounding box to the external system.

At this point, the external system can send an alert to the terminal of the person reflected in prediction region 1001 and to the terminal of the person reflected in prediction region 1002.

Next, the second detection unit 5 selects the prediction region 1003 and identifies the label of the object reflected in the prediction region 1003 and the location of the bounding box of the object. The second detection unit 5 then outputs the label and the location of the bounding box to the external system.

At this point, the external system can send an alert to the terminal of the person reflected in prediction region 1001 and to the terminal of the person reflected in prediction region 1003.

Suppose that the order of prediction region 1004 is earlier than the order of prediction regions 1001, 1002, and 1003. Then, the second detection unit 5 would select prediction region 1004 first and output the label of the object reflected in prediction region 1004 and the location of the bounding box of the object to the external system. This would delay the timing of sending alerts to the terminals of the persons reflected in prediction regions 1001, 1002, and 1003, respectively.

However, in the present example embodiment, the ordering unit 8 performs ordering on the predicted regions of the bounding boxes as described above. Thus, delays in alert sending timing by external systems can be prevented.

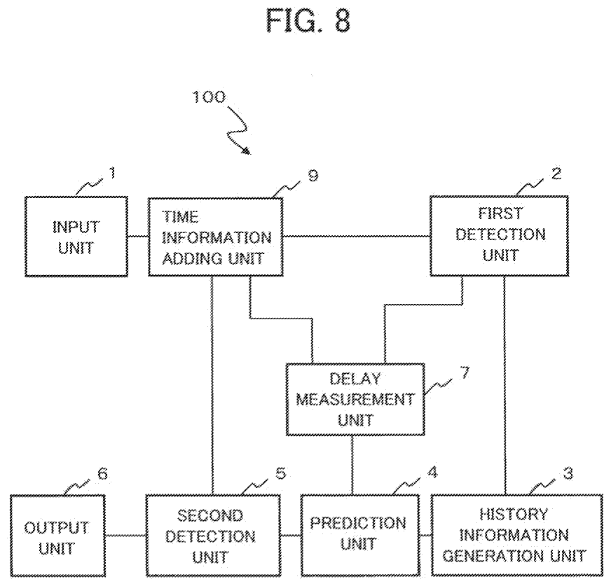

Next, a variation of the example embodiments of the present invention will be described. The object detection system 100 of the first through third example embodiments described above uses frame numbers. In each example embodiment, the object detection system 100 may use the time when the frame is input to the input unit 1 instead of the frame number. FIG. 8 is a block diagram showing an example of an object detection system that uses the time when a frame is input. FIG. 8 shows an example of the second example embodiment (see FIG. 4) with the addition of a time information adding unit 9, but the object detection system may be configured by adding the time information adding unit 9 to the first example embodiment (see FIG. 1) or the third example embodiment (see FIG. 6). Explanations are omitted for matters similar to those already explained.

When a frame is input to the input unit 1, the time information adding unit 9 adds time information indicating the time at that point to the frame and outputs the frame to the first detection unit 2 and the second detection unit 5. The time information adding unit 9 also outputs the time information to the delay measurement unit 7. The time information adding unit 9 is realized, for example, by a CPU of a computer that operates according to an object detection program.

The first detection unit 2 outputs the time information added to the frame, the label, and the location of the bounding box to the history information generation unit 3. The first detection unit 2 also outputs the time information to the delay measurement unit 7.

The history information generation unit 3 generates history information indicating the history of the combination of time information, the label, and the location of the bounding box, for each ID of the bounding box.

The delay measurement unit 7 measures the difference between the time added to the latest frame and the time given by the first detection unit 2 as the magnitude of the delay in the first detection unit 2.

The prediction unit 4 predicts the region of the bounding box in the frame corresponding to the time when the time corresponding to the difference is added to the latest time in the history information.

In the configuration where the time information adding unit 9 is added to the first example embodiment, the prediction unit 4 predicts the region of the bounding box in the frame corresponding to the time when predetermined time is added to the latest time in the history information.

Other aspects are the same as for each of the previously described example embodiments.

This variation also has the same effect as each of the above example embodiments.

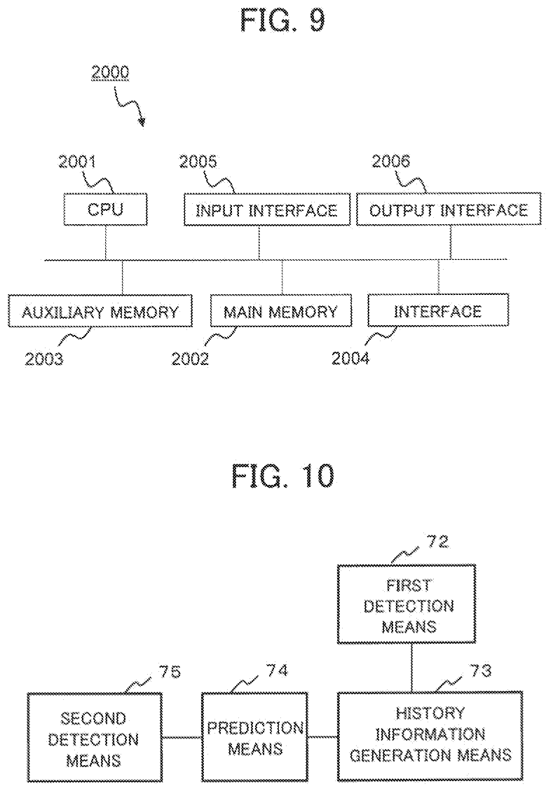

FIG. 9 is a schematic block diagram showing an example configuration of a computer related to the object detection system 100 of the present invention. The computer 2000, for example, includes a CPU 2001, a main memory 2002, an auxiliary memory 2003, an interface 2004, an input interface 2005, and an output interface 2006.

The object detection system 100 of each example embodiment of the present invention is realized, for example, by a computer 2000. The operation of the object detection system 100 is stored in the auxiliary memory 2003 in the form of a program (object detection program). The CPU 2001 reads the program from the auxiliary memory 2003, expands the program in the main memory 2002, and executes the process described in each of the above example embodiments and the variations, according to the program.

The auxiliary memory 2003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 2004.

As already described, the object detection system may be realized by a combination of an FPGA and an AI chip. The object detection system may also be realized by a combination of an edge device and a server.

The following is an overview of the present invention. FIG. 10 is a block diagram showing an overview of the object detection system of the present invention. Frames are continuously input to the object detection system of the present invention. The object detection system of the present invention includes first detection means 72, history information generation means 73, prediction means 74, and second detection means 75.

The first detection means 72 (e.g., the first detection unit 2) identifies labels of objects reflected in a input frame and locations of bounding boxes of the objects.

The history information generation means 73 (e.g., the history information generation unit 3) assigns the same ID to the bounding boxes that share the same object, and generates history information that is information indicating a history of combination of a frame number and a location of a bounding box for each ID.

The prediction means 74 (e.g., the prediction unit 4) predicts regions of the bounding boxes in latest frame, based on the history information, according to a delay that is a time required for the first detection means 72 to identify the labels and the locations of the bounding boxes in the input frame.

The second detection means 75 (e.g., the second detection unit 5) identifies labels of reflected objects and locations of bounding boxes, in predicted regions of the bounding boxes in the latest frame.

Processing time for the second detection means 75 to identify the labels and the locations of the bounding boxes for one frame is shorter than processing time for the first detection means 72 to identify the labels and the locations of the bounding boxes for the one frame.

According to such a configuration, both low delay and object detection accuracy can be achieved.

The object detection system may also be configured to include delay measurement means (e.g., the delay measurement unit 7) that measures magnitude of the delay.

The delay measurement means may measure a difference between the frame number of the latest frame and the frame number of the input frame in which the first detection means 72 identifies the labels of the objects and the locations of the bounding boxes, as the magnitude of the delay, and the prediction means 74 may predict the regions of the bounding boxes in the latest frame according to the difference.

The prediction means 74 may predict the regions of the bounding boxes in the latest frame by linear prediction based on the history information.

The prediction means 74 may predict the regions of the bounding boxes in the latest frame by Kalman filter based on the history information.

The object detection system may also be configured to include ordering means (e.g., the ordering unit 8) that performs ordering on the regions of the bounding boxes predicted by the prediction means 74, and the second detection means 75 may select a region of a bounding box in order determined by the ordering means, and identifies a label of an object reflected and a location of the object in the region.

For example, the ordering means determines order of the regions of the bounding boxes that meet a condition that distance between the predicted regions of two bounding boxes is equal to or less than a predetermined threshold and direction of movement of the two bounding boxes is facing each other, is earlier than order of the regions of the bounding boxes that does not meet the condition.

As mentioned above, when an object is detected in a high-resolution frame, it takes longer to detect the object. Therefore, an object detection system to which frames generated by a high-resolution camera are continuously input cannot output detection results in real time. In other words, such an object detection system will have a delay before outputting the detection result of an object in the latest input frame. When using small and lightweight detection algorithms and model structures that can detect objects in a short time, the accuracy of object detection is reduced, as described above.

According to the present invention, both low delay and object detection accuracy can be achieved.

The invention is suitably applied to an object detection system that detects an object in frames.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1 Input unit
2 First detection unit
3 History information generation unit
4 Prediction unit
5 Second detection unit
6 Output unit
7 Delay measurement unit
8 Ordering unit
100 Object detection system

What is claimed is:

1. An object detection system to which frames are input continuously, comprising:
a memory storing instructions; and
a processor configured to execute the instructions to implement:
a first detection unit that identifies labels of objects reflected in a input frame and locations of bounding boxes of the objects;
a history information generation unit that assigns the same ID to the bounding boxes that share the same object, and generates history information that is information indicating a history of combination of a frame number and a location of a bounding box for each ID;
a prediction unit that predicts regions of the bounding boxes in latest frame, based on the history information, according to a delay that is a time required for the first detection unit to identify the labels and the locations of the bounding boxes in the input frame; and
a second detection unit that identifies labels of reflected objects and locations of bounding boxes, in predicted regions of the bounding boxes in the latest frame;
wherein processing time for the second detection unit to identify the labels and the locations of the bounding boxes for one frame is shorter than processing time for the first detection unit to identify the labels and the locations of the bounding boxes for the one frame.

2. The object detection system according to claim 1,
wherein the processor is further configured to execute the instructions to implement:
a delay measurement unit that measures magnitude of the delay.

3. The object detection system according to claim 2,
wherein the delay measurement unit measures a difference between the frame number of the latest frame and the frame number of the input frame in which the first detection unit identifies the labels of the objects and the locations of the bounding boxes, as the magnitude of the delay, and
the prediction unit predicts the regions of the bounding boxes in the latest frame according to the difference.

4. The object detection system according to claim 1,
wherein the prediction unit predicts the regions of the bounding boxes in the latest frame by linear prediction based on the history information.

5. The object detection system according to claim 1,
wherein the prediction unit predicts the regions of the bounding boxes in the latest frame by Kalman filter based on the history information.

6. The object detection system according to claim 1,
wherein the processor is further configured to execute the instructions to implement:
an ordering unit that performs ordering on the regions of the bounding boxes predicted by the prediction unit, and
wherein the second detection unit selects a region of a bounding box in order determined by the ordering unit, and identifies a label of an object reflected and a location of the object in the region.

7. The object detection system according to claim 6,
wherein the ordering unit determines order of the regions of the bounding boxes that meet a condition that distance between the predicted regions of two bounding boxes is equal to or less than a predetermined threshold and direction of movement of the two bounding boxes is facing each other, is earlier than order of the regions of the bounding boxes that does not meet the condition.

8. An object detection method applied to a computer to which frames are input continuously, comprising:
executing a first detection process of identifying labels of objects reflected in a input frame and locations of bounding boxes of the objects;
executing a history information generation process of assigning the same ID to the bounding boxes that share the same object, and generating history information that is information indicating a history of combination of a frame number and a location of a bounding box for each ID;
executing a prediction process of predicting regions of the bounding boxes in latest frame, based on the history information, according to a delay that is a time required in the first detection process to identify the labels and the locations of the bounding boxes in the input frame; and
executing a second detection process of identifying labels of reflected objects and locations of bounding boxes, in predicted regions of the bounding boxes in the latest frame;
wherein processing time in the second detection process to identify the labels and the locations of the bounding boxes for one frame is shorter than processing time in the first detection process to identify the labels and the locations of the bounding boxes for the one frame.

9. A non-transitory computer-readable recording medium in which an object detection program is recorded, wherein the object detection program is to be installed in a computer to which frames are input continuously, and the object detection program causes the computer to execute:
a first detection process of identifying labels of objects reflected in a input frame and locations of bounding boxes of the objects;
a history information generation process of assigning the same ID to the bounding boxes that share the same object, and generating history information that is information indicating a history of combination of a frame number and a location of a bounding box for each ID;
a prediction process of predicting regions of the bounding boxes in latest frame, based on the history information, according to a delay that is a time required in the first detection process to identify the labels and the locations of the bounding boxes in the input frame; and
a second detection process of identifying labels of reflected objects and locations of bounding boxes, in predicted regions of the bounding boxes in the latest frame;
wherein processing time in the second detection process to identify the labels and the locations of the bounding boxes for one frame is shorter than processing time in the first detection process to identify the labels and the locations of the bounding boxes for the one frame.
